(19) United States
(12) Patent Application Publication
(10) Pub. No.: US 2009/0217382 A1
(43) Pub. Date: Aug. 27, 2009

(54) METHOD AND PROCEDURE TO AUTOMATICALLY DETECT ROUTER SECURITY CONFIGURATION CHANGES AND OPTIONALLY APPLY CORRECTIONS BASED ON A TARGET CONFIGURATION

(75) Inventor: Paul A. Lecheler, Allen, TX (US)

Correspondence Address: HITT GAINES, PC;ALCATEL-LUCENT, PO BOX 832570, RICHARDSON, TX, 75083, US

(73) Assignee: Alcatel-Lucent, Paris (FR)

(21) Appl. No.: 12/036,959

(22) Filed: Feb. 25, 2008

(51) Int. Cl. H04L 9/00; G06F 17/30

(52) U.S. Cl. 726/26; 707/100; 707/E17.01

(57) ABSTRACT

A method for maintaining router security configuration files, a method for detecting unauthorized changes to router security configurations and a network controller. In one embodiment, the method for maintaining includes: (1) generating a target-delta file having commands needed to make identified data blocks of a baseline file functionally equivalent to corresponding data blocks of a target file, wherein the identified data blocks are functionally different from the corresponding data blocks of the target file and (2) changing a router security configuration field file by applying the target-delta file thereto.

### TECHNICAL FIELD OF THE INVENTION

The invention is directed, in general, to comparing complex computer files and, more specifically, to comparing and detecting changes in configuration files.

### BACKGROUND OF THE INVENTION

Computer networks include multiple computing devices connected together. Routers are often used to connect a plurality of the computer networks to each other. Routers operate on the Network layer of the OSI conceptual model to route data from a source device on a computer network to at least one destination device on a computer network. Various connection ports of the routers are configured to correctly direct the data from the source device to the destination device. Security configuration files loaded on the routers are used to control the configuration of the ports.

Router security configuration files are complex files containing thousands of statements. To maintain accurate interconnectivity between networks, the router security configurations need to be accurate. Accurately identifying the changes that are required to bring a network security device into conformance can be complex, time consuming, and prone to error. Typically, an engineer will manually compare existing security configuration files with desired security configuration files to determine the changes needed. However, an experienced engineer may require 8-10 hours to develop a suitable change configuration file to be applied to a router with more than 2000 rules in place.

A software tool such as “Diff” may be used to assist in the comparison. “Diff” is a UNIX command that compares the contents of two files, a source file and a target file, and produces a “delta” file having lines that are changed or absent in either of the source or target file. Diff or other conventional comparison tools, however, do not perform as well for multi-line complex security configuration files where changes usually include the insertion of multi-line entries.

### SUMMARY OF THE INVENTION

To address the above-discussed deficiencies of the prior art, one aspect of the disclosure provides a method for maintaining router security configuration files. In one embodiment, the method includes: (1) generating a target-delta file having commands needed to make identified data blocks of a baseline file functionally equivalent to corresponding data blocks of a target file, wherein the identified data blocks are functionally different from the corresponding data blocks of the target file and (2) changing a router security configuration field file by applying the target-delta file thereto.

In another aspect, the disclosure provides a method for detecting unauthorized changes to router security configurations. In one embodiment, the method includes: (1) generating a delta file having identified data blocks of a router security configuration field file, wherein the identified data blocks of the field file are functionally different from corresponding data blocks of a router security configuration baseline file and (2) generating an alarm based on the identified data blocks in the delta file.

In yet another aspect, the disclosure provides a network controller. In one embodiment, the network controller includes a configuration guardian having: (1) an intelligent delta tool operable to compare data blocks of a field configuration file with corresponding data blocks of a target configuration file and generate a target-delta file that represents functional differences between the data blocks and (2) a configuration monitor operable to modify the field configuration file based on the target-delta file to make the field configuration file functionally equivalent to the target configuration file.

### BRIEF DESCRIPTION OF THE DRAWINGS

For a more complete understanding of the invention, reference is now made to the following descriptions taken in conjunction with the accompanying drawings, in which:

FIG. 1 illustrates a block diagram of an embodiment of a configuration guardian constructed according to the principles of the disclosure;

FIG. 2 illustrates a block diagram of a computer network including an embodiment of a network controller constructed according to the principles of the disclosure;

FIG. 3 illustrates a flow diagram of an embodiment of a method of maintaining router security configuration files carried out according to the principles of the disclosure; and

FIG. 4 illustrates a flow diagram of an embodiment of a method of detecting unauthorized changes to router security configurations carried out according to the principles of the disclosure.

### DETAILED DESCRIPTION

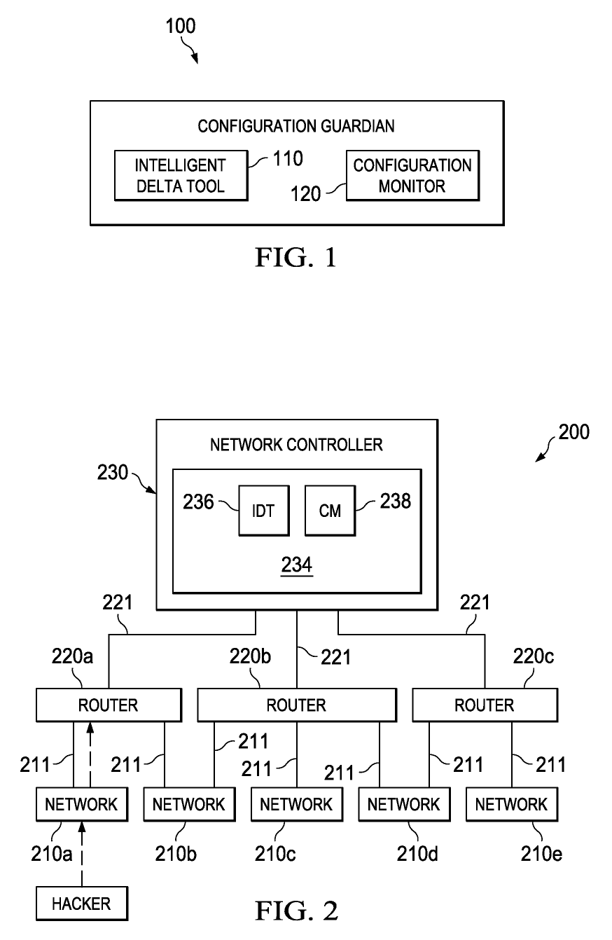

FIG. 1 illustrates a block diagram of an embodiment of a configuration guardian 100 constructed according to the principles of the disclosure. The configuration guardian 100 is configured to analyze two computer files, a source file and a target file, and produce “delta” files that represent changes needed to functionally conform the source file to the target file. Unlike conventional comparison tools that perform a line-by-line comparison of two files, the configuration guardian 100 compares corresponding data blocks of the target and source files and generates a delta file that represents the changes needed to a data block of the source file to perform as the corresponding data block of the target file. Thus, instead of a delta file that includes differences betweens lines of two files, the configuration guardian 100 generates a delta file that includes comprehensive changes needed to a data block to alter the function of the data block. A data block of a computer file is a multi-line unit of data or commands that cooperate to define or perform a particular function. The multi-line unit of data or commands forming a data block is characterized by defining or performing a common function. The configuration guardian 100, therefore, is beneficial for maintaining complex files such as configuration files that include thousands of lines of data organized in data blocks. For example, Alcatel-Lucent routers, such as an Alcatel-Lucent 7750 Surface Router (SR), include security configuration files that are identified by entries and entry numbers. The configuration guardian 100, however, is not limited to configuration files but can be used to compare other computer files having data that is identifiable in blocks such as the entries.

The configuration guardian 100 may be a dedicated apparatus constructed of special-purpose hardware employing a series of operating instructions which direct its operation. In alternative embodiments, the configuration guardian 100 may be implemented on a general purpose computing device directed by a sequence of operating instructions. The configuration guardian 100, for example, may be implemented on a server. The configuration guardian 100 includes an intelligent delta tool 110 and a configuration monitor 120. The configuration monitor 120 may be embodied as a script file.

The intelligent delta tool 110 is configured to compare data blocks of a source file with corresponding data blocks of a target file and generate a target-delta file that represents functional differences between the data blocks. The configuration monitor 120 is configured to modify the source file based on the target-delta file to make the source file functionally equivalent to the target configuration file. Functionally equivalent is when a group of commands perform the same function as another group of commands irregardless if the commands in the groups are not the same. Thus, a data block in one file may have different commands from a data block in another file but can be functionally equivalent if both data blocks provide the same outcome for the same input data.

The configuration monitor 120 may also be configured to generate alarms when detecting an unexpected alteration to the source file. The alteration, for example, may be an unauthorized change. The configuration monitor 120 may be configured to generate an alarm based on if the alteration occurs within a protected data block. A protected data block may be a reserved range or reserved ranges of a data blocks protected for use by a particular party. As such, a protected data block may be a designated data block or group of data blocks of a computer file that has been apportioned for particular programming. In some embodiments, a protected block may be a designated group of data blocks that has been set-aside for use by a third party. For example, the source and target computer files may be security configuration files of a router with data blocks that are identified as entries. A designated group of entry numbers may be considered a protected block that has been set-aside for programming by a particular party. The particular party may be managers of a network system or a user of the network system having permission to make changes in the protected block. Therefore, a protected block may be considered as a data block or blocks reserved for a particular party or, alternatively, a data block protected against other parties. Thus, the configuration monitor 120 may generate an alarm only when the alteration is within a protected block. Alternatively, the configuration monitor 120 may generate an alarm only when the alteration is outside of a protected block.

The configuration guardian 100 may be employed to monitor and maintain complex computer files such as configuration files. As discussed with respect to FIG. 2, a configuration guardian may be employed in a network system to monitor and maintain the security configuration files of the routers in the network system.

FIG. 2 illustrates a block diagram of a network system 200 including an embodiment of a network controller 230 having a configuration guardian 234 constructed according to the principles of the disclosure. The network system 200 includes computer networks 210a-210e, routers 220a-220c and the network controller 230. One skilled in the art will understand that the network system 200 may include additional components that are not illustrated or discussed.

The computer networks 210a-210e comprise a plurality of computing or network devices including, but not limited to, switches, desktops, laptops, remote access devices, terminals, firewalls, bridges, etc. The computer networks 210a-210e may be various types of networks and employ different topologies, protocols or architectures. For example, at least one of the computer networks 210a-210e may be a local-area network (LAN) employing the Ethernet protocol. Each of the computer networks 210a-210e is connected to at least one of the routers 220a-220c via a path 211. The routers 220a-220c connect each of the computer networks 210a-210e to at least one other of the computer networks 210a-210e.

The routers 220a-220c forward data packets between the computer networks 210a-210e via the paths 211. Security configuration files on each of the routers 220a-220c control the configuration of the router ports and direct the data packets through the correct ports to deliver the data packets from a source device to a destination device. The routers 220a-220b, for example, may use forwarding tables to direct data packets from a source device in computer network 210c to a destination device in computer network 210a. In this example, router 220b would forward the data packets from computer network 210c, through computer network 210b to router 220a. Router 220a would then direct the data packets to the destination device in computer network 210a.

The network controller 230 monitors the physical and operating parameters of the network system 200. The network controller 230 may be a server that is located in a network operating center for the network system 200. The network controller 230 is connected to the routers 220a-c via data links 221. The network controller 230 includes a configuration guardian 234 that includes an intelligent delta tool 236 and a configuration monitor 238. The configuration guardian 234 is configured to maintain the configuration files of the routers 220a-220c. As described herein, the configuration guardian 234 maintains the security configuration files for each of the routers 220a-220c.

Router security configurations are complex and contain thousands of statements that need to be accurate to properly route data. Typically, the security configuration of an active router is changed under two circumstances. In the first instance, the security configuration of a router is changed when an authorized change is required. An authorized change, for example, may be due to new services being added to the network system 200 or an expansion of the existing services. In a second instance, the security configuration of a router is changed by an unauthorized attacker. For example, the hacker in FIG. 2 may make a subtle change to the security configuration file of the router 220a to permit unauthorized access to devices of the network system 200.

In both circumstances, three state configurations are used to detect changes and create a “correction” file that is used to repair or alter the security configurations. These files are: 1) a “baseline” security configuration file, 2) a “field” deployed security configuration file and 3) a “target” security configuration file. The baseline configuration file represents the original security configurations or the authorized updated security configurations for the routers 220a-c. The baseline configuration files for each of the routers 220a-c are archived to provide a back-up for the field configuration files and a standard used to detect unauthorized changes to the field configuration files. The network controller 230 includes a baseline configuration file of the security configurations for each of the routers 220a-c. The baseline files may be stored in the configuration guardian 234 portion of the network controller 230 or in another memory section of the network controller 230. Ideally, the baseline configuration files, or at least the non-reserved ranges, comport with the security configuration files that are loaded on the routers 220a-c. The security configuration files that are loaded on the routers 220a-c and direct the operation thereof are referred to as field configuration files. The target configuration file is a desired security configuration file that includes the commands to implement new services being added to the network system 200 or an expansion of existing services. The target configuration file may be created manually. In some situations, an engineer, computer programmer, technician, etc., may use an internally developed tool to assist in creating the target configuration.

Due to the complex nature of these security configuration files, it is difficult to accurately detect differences among them. To maintain the proper security configurations for the routers 220a-c, the intelligent delta tool 236 can compare complex multi-line entries (i.e., data blocks) in the various security configuration files and generate delta files that only include needed changes to make the corresponding data blocks functionally equivalent. For implementing authorized changes, the intelligent delta tool 236 can compare the field configuration files with corresponding data blocks of a target configuration file and generate a target-delta file that represents functional differences between the data blocks. The target-delta file includes the commands required to change the field configuration files in the routers 220a-c from the “field” state to the “target” state. The configuration monitor 238 can then modify the field configuration file based on the target-delta file to make the field configuration file functionally equivalent to the target configuration file.

Application of the target-delta file as described above assumes that the field configuration files of the routers 220a-c match the baseline configuration files (e.g., the original state). To confirm this is true, the intelligent delta tool 236 is configured to compare data blocks of the baseline configuration file with corresponding data blocks of the field configuration file and generate a field-delta file that represents functional differences therebetween. If the two configurations are functionally equivalent, the change may proceed using the target-delta file. If not, an unauthorized change has been made to the field configuration file and an alarm condition is raised. The field configuration file is then reviewed to determine the unauthorized changes. The review may be performed manually.

In the second case noted above where an unauthorized attacker has made changes, the intelligent delta tool 236 performs a comparison of a baseline configuration file to a corresponding field configuration file. If changes are detected, an alarm is raised that indicates the need for further investigation. In order to detect unauthorized changes, the configuration monitor 238 may direct the intelligent delta tool 236 to compare the original and field configurations files periodically.

In some routers, such as routers 220a-c, merely reapplying configuration statements is not sufficient to correct security configurations since the command syntax specifies that many of the configuration parameters are optional. Thus, merely replacing the field configuration files with the baseline configuration files can result in corrupted configurations. For example, assume the field configuration file for router 220a allows data packets from a TCP port 80 source A. The operator of the network system 200 wishes to change this rule to allow data packets from TCP port 81 destination B. If the rule were modified by overwriting, the resultant rule would allow packets from TCP port 81 source A destination B. The error “source A” should be removed. However, since it was not specified in the change, the value remained. Table 1 below demonstrates that the “desired” rule change and the actual “result” do not match when simply overwriting. Instead, the router field configuration file is corrupted. To prevent this type of corruption, for example, the intelligent delta tool 236 considers changes that are needed in context for each data block to produce the proper command syntax when creating a delta file. Thus, the intelligent delta tool 236 may consider each of the multi-line commands in a data block and determine which commands should be added, altered and/or deleted.

TABLE 1

| | Source | Destination | Protocol | Port | Action |
|---|---|---|---|---|---|
| Original | A | Unspecified | TCP | 80 | Permit |
| Target | Unspecified | B | Unspecified | 81 | Permit |
| Result | A | B | TCP | 81 | Permit |
| Desired | Unspecified | B | Unspecified | 81 | Permit |

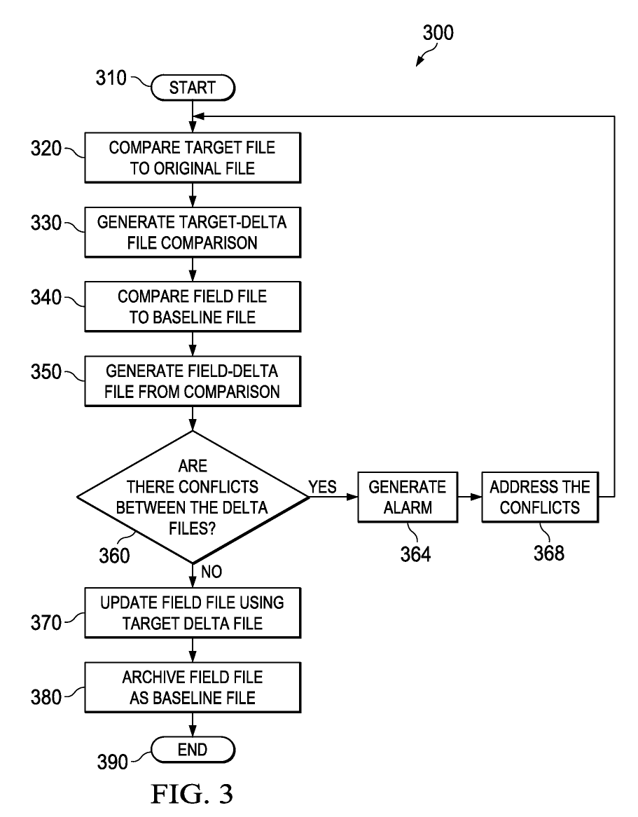

FIG. 3 illustrates a flow diagram of an embodiment of a method 300 of maintaining router security configuration files carried out according to the principles of the disclosure. The method 300 may be implemented as a series of algorithms that direct the operation of computer readable medium. The method 300, for example, may be embodied on a server such as the network controller 230 of FIG. 2. The method 300 begins in a step 310 with the intent to change a security configuration field file on a router.

The method 300 continues by comparing a target configuration file to a baseline configuration file in a step 320. When comparing, data blocks of the baseline configuration file that are functionally different from corresponding data blocks of the target configuration file are identified. Comparing the two files may include storing the baseline configuration file and the target configuration file in first and second tables, respectively, created in a memory. The first table may be referred to as the baseline table and the second table may be referred to as a target table. A filter may be used to read the files into the tables. The data blocks of the files may be stored as entries in the tables. Each of the baseline table and the target table can be organized according to data block numbers. In some embodiments, the baseline table and the target table can be established within a memory of a network controller.

After comparing the files, a target-delta file is generated in a step 330. The target-delta file has commands needed to make the identified data blocks of the baseline configuration file functionally equivalent to the corresponding data blocks of the target configuration file. The commands address changes that need to be made to the identified data blocks at a data block level. Thus, each line of the data block is considered in context to determine the comprehensive changes that are needed to make the corresponding blocks functionally equivalent.

The generating may include excluding a data block number from the target-delta file when the data block number is in the baseline table but is not in target table. In some embodiments, the generating includes copying data from an identified data block, a certain data block number, from the target table to the target-delta file when the data block number is in the target table but is not in the baseline table. Additionally, one embodiment may include excluding a data block number from the target-delta file when the data block number is found in both the baseline table and the target table and all fields in the data block of the baseline table and the target table are equivalent. The generating may also include copying data from the target table to the target-delta file when a data block number is found in both the baseline table and the target table and all fields in the data block of the baseline table and the target table are not equivalent.

The field configuration file is then compared to the baseline configuration file in a step 340. Data blocks of the field configuration file that are functionally different from corresponding data blocks of the baseline configuration file are identified.

After comparing the security configuration field file and the baseline file, a field-delta file is generated in a step 350. The field-delta file has commands needed to make the identified data blocks of the field file functionally equivalent to the corresponding data blocks of the baseline file. Two tables may also be used as described above to perform the comparison between the field and baseline configuration files. In this aspect, the two tables may be referred to as the field table and the baseline table. Additionally, the above generating rules discussed above for generating the target-delta file may also be used to generate the field-delta file.

A determination is then made in a decision step 360 if there are conflicts between the target-delta file and the field-delta file. A conflict can occur when the both of the delta files have the same data blocks that are identified. For example, the target-delta file and the field-delta file may both include commands for data block number 1000. If there are no conflicts, the method 300 proceeds to step 370 where the security field configuration file is updated using the target-delta file. The security configuration field file is then archived as the baseline configuration file in a step 380. As such, the new baseline configuration file becomes the field configuration file that is upgraded with respect to the target configuration file. The method 300 then ends in a step 390.

Turning back to the decision step 360, if there are conflicts between the target-delta file and the field-delta file, an alarm is generated in a step 264. An alarm may be generated if there is a conflict between identified data blocks of the target-delta file and the field-delta file. The alarm may be received and processed in various ways. For example, the managers of the network may determine to generate a text message to a designated monitor to indicate a problem needs to be addressed when an alarm occurs. Alternatively, an exception log may be generated requiring a technician to analyze the conflicts and determine how to address the conflicts. In some instances, the technician may reject some of the changes, reject all of the changes or manually resolve some or all of the conflicts.

The generated alarm results in the conflicts being addressed in a step 368. Addressing the conflicts may include determining if the identified data blocks are within a protected block. If the conflicts are within a protected block, for example, data block numbers 2000 to 2100, no changes may be needed by the operator of the router. Instead, these changes can be addressed by a third party user of the router. If the conflicts are not within a protected block, then the router operator will need to determine how to address the conflicts. Addressing the conflicts may involve manually analyzing the affected data blocks and determining the proper correction that is needed. After the conflicts are addressed, the method 300 continues to step 320.

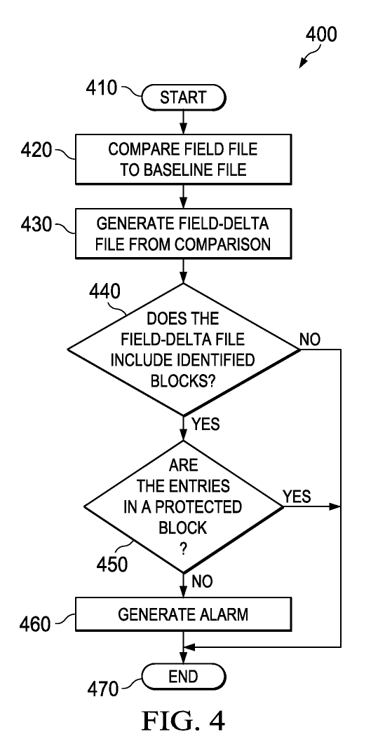

FIG. 4 illustrates a flow diagram of an embodiment of a method 400 of detecting unauthorized changes to router security configurations carried out according to the principles of the disclosure. The method 400 may be implemented as a series of algorithms that direct the operation of computer readable medium. The method 400, for example, may be embodied on a server such as the network controller 230 of FIG. 2. The method 400 begins with the intent of checking the existing security field configuration file in a step 410.

After starting, the method 400 continues by comparing the security field configuration file with a baseline configuration file in a step 420. A field-delta file is then generated from the comparison in a step 430. Comparing and generating the field-delta file may be performed as discussed above with respect to FIG. 3. An intelligent delta tool may do the comparing and the generating.

A determination is then made in a first decision step 440 if the field-delta file includes data in identified data blocks. A configuration monitor may make the determination in cooperation with an intelligent delta tool. If the field-delta file does include data in identified data blocks, then a determination is made if the data is in a protected block in a second decision step 450. If the data is in a protected block, then the change may be performed by a particular party that is authorized to make changes therein. In some embodiments, an alarm may be generated when a change is detected in a protected block. The particular party can then be notified to investigate. The system manager may also investigate to insure that changes were not inadvertently made by an authorized user to a protected block. As represented herein, alarms for detected changes in protected blocks may be suppressed.

If the data is not in a protected block, then an alarm is generated in a step 460. The generated alarm will notify a party to investigate the field-delta file and the noted changes detected. The changes detected may indicate unauthorized changes. The method 400 then continues to step 470 and ends.

Returning to the first decision step 440, if the field-delta file does not include data in identified data blocks, then the method 400 proceeds to step 470 and ends. Returning to the second decision step 450, if the data in the field-delta file is within a protected block, then the method 400 proceeds to step 470 and ends.

The above-described system, apparatus and methods may be embodied in or performed by various conventional digital data processors or computers, wherein the computers are programmed or store executable programs of sequences of software instructions to perform one or more of the steps of the methods, e.g., steps of the method of FIGS. 3-4. The software instructions of such programs may be encoded in machine-executable form on conventional digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, e.g., one or more of the steps of the method of FIGS. 3-4.

Those skilled in the art to which the invention relates will appreciate that other and further additions, deletions, substitutions and modifications may be made to the described embodiments without departing from the scope of the invention.

What is claimed is:

1. A method of maintaining router security configuration files, comprising:
generating a target-delta file having commands needed to make identified data blocks of a baseline file functionally equivalent to corresponding data blocks of a target file, wherein said identified data blocks are functionally different from said corresponding data blocks of said target file; and
changing a router security configuration field file by applying said target-delta file thereto.

2. The method as recited in claim 1 further comprising generating a field-delta file having commands needed to make identified data blocks of said field file functionally equivalent to corresponding data blocks of said baseline file, wherein said identified data blocks of said field file are functionally different from said corresponding data blocks of said baseline file.

3. The method as recited in claim 2 further comprising determining if there are any conflicts between said target-delta file and said field-delta file.

4. The method as recited in claim 3 further comprising generating an alarm if there is a conflict between identified data blocks of said target-delta file and said field-delta file.

5. The method as recited in claim 4 further comprising examining said conflict.

6. The method as recited in claim 5 wherein said examining includes determining if said identified data blocks are within a protected block.

7. The method as recited in claim 1 further comprising archiving said field file as said baseline file.

8. The method as recited in claim 1 wherein said commands address changes to said identified data blocks at a block level.

9. The method as recited in claim 1 wherein said baseline file is stored in a first table and said target file is stored in a second table, wherein each of said first and second tables are organized according to data block numbers.

10. The method as recited in claim 9 wherein said generating includes excluding a data block number from said target-delta file when said data block number is in table one but is not in table two.

11. The method as recited in claim 9 wherein said generating includes copying data associated with a data block number from table two to said target-delta file when said data block number is in table two but is not in table one.

12. The method as recited in claim 9 wherein said generating includes excluding a data block number from said target-delta file when said data block number is found in both table one and table two and all fields in said data block of table one and table two are equivalent.

13. The method as recited in claim 9 wherein said generating includes copying data from table two to said target-delta file when a data block number is found in both table one and table two and all fields in said data block of table one and table two are not equivalent.

14. For use in a network having routers, a method of detecting unauthorized changes to router security configurations, comprising:
(a) generating a delta file having identified data blocks of a router security configuration field file, wherein said identified data blocks of said field file are functionally different from corresponding data blocks of a router security configuration baseline file; and
(b) generating an alarm based on said identified data blocks in said delta file.

15. The method as recited in claim 14 wherein said steps (a) to (b) are performed periodically.

16. The method as recited in claim 14 further comprising determining if said identified data blocks are within a protected block.

17. The method as recited in claim 16 further comprising generating said alarm based on if said identified data blocks are within said protected block.

18. A network controller, comprising:
a configuration guardian, including:
an intelligent delta tool operable to compare data blocks of a field configuration file with corresponding data blocks of a target configuration file and generate a target-delta file that represents functional differences between said data blocks; and
a configuration monitor operable to modify said field configuration file based on said target-delta file to make said field configuration file functionally equivalent to said target configuration file.

19. The network controller of claim 18 wherein said intelligent delta tool is further operable to compare data blocks of an original configuration file with corresponding data blocks of said field configuration file and generate a field-delta file that represents functional differences therebetween.

20. The network controller of claim 19 wherein said configuration monitor directs said intelligent delta tool to compare said original and field configurations files periodically.

21. The network controller as recited in claim 18 wherein said field configuration file is a security configuration file of a router.
